(19) United States
(12) Patent Application Publication
(10) Pub. No.: US 2015/0104132 A1
(43) Pub. Date: Apr. 16, 2015

(54) OPTICAL FIBER WITH OPTICAL CONNECTORS

(71) Applicant: JAPAN AVIATION ELECTRONICS INDUSTRY, LIMITED, Tokyo (JP)

(72) Inventors: Yuichi KOREEDA, Tokyo (JP); Naoki KATAGIYAMA, Tokyo (JP)

(21) Appl. No.: 14/317,379

(22) Filed: Jun. 27, 2014

(30) Foreign Application Priority Data
Oct. 11, 2013 (JP) 2013-213654

(51) Int. Cl. G02B 6/38

(52) U.S. Cl. CPC G02B 6/3807; G02B 6/3897
USPC 385/76

(57) ABSTRACT

Disclosed is an optical fiber that has optical connectors on opposing ends of the optical fiber and is used for optical wiring in an apparatus. The two optical connectors are connected in parallel directions and disposed in parallel with each other. The optical fiber between the two optical connectors includes a linear portion and two bent portions positioned between the ends of the linear portion and the optical connectors. The bent portions are formed by application and curing of resin to obtain a circular shape having a central angle of 90°, which provides a curvature radius not smaller than the allowable curvature radius of the optical fiber. This optical fiber with optical connectors makes it possible to considerably reduce the space required for optical wiring as compared with the prior art.

### TECHNICAL FIELD

The present invention relates to an optical fiber that has optical connectors on opposing ends thereof and is used for optical wiring in an apparatus.

### BACKGROUND ART

When subjected to an excessive bending stress, an optical fiber may degrade its transmission characteristics and become damaged. Therefore, when the optical fiber is to be bent, it must be bent to a curvature radius not smaller than an allowable curvature radius.

FIG. 1 illustrates a configuration described in Japanese Patent Application Laid Open No. H07-98417 (issued on Apr. 11, 1995) as a prior-art example in which an optical fiber is wired so that it is not bent to a curvature radius equal to or smaller than a certain curvature radius. In FIG. 1, reference numeral 11 denotes an optical fiber cable with optical connectors on opposing ends thereof, and reference numeral 12 denotes a support plate to which a cushion 13 having a plurality of slits 13a is fastened. The slits 13a are spaced at a predetermined interval so that the optical fiber cable 11 is inserted into the slits 13a without being bent to a curvature radius equal to or smaller than a predetermined curvature radius. Reference numeral 14 denotes a panel to which a plurality of optical adapters 15 with a flange are fastened. The optical adapters 15 are connected to either one of the optical connectors of the optical fiber cable 11. Reference numeral 16 denotes screws that fasten first and second retention plates 17a, 17b to the support plate 12. The first and second retention plates 17a, 17b are bent so as to cover the slits 13a in the cushion 13 into which the optical fiber cable 11 is inserted, prevent the optical fiber cable 11 from dropping off, and properly secure the optical fiber cable 11.

One of the optical connectors of the optical fiber cable 11 is connected to an optical adapter 15 with a flange, which is mounted on the panel 14. A cable portion of the optical fiber cable 11 is inserted into a slit 13a in the cushion 13 that is disposed flush with the position of the connected optical connector. The leading end of the inserted cable portion is semicircularly bent so that the bending radius of the optical fiber cable 11 is maintained equal to a predetermined radius, and then inserted into the next slit 13a.

When the interval between the slits 13a is greater than two times the allowable curvature radius of the optical fiber cable 11, the above-described configuration maintains a constant bending radius without degrading the transmission characteristics of the optical fiber cable 11. An extra length of the optical fiber cable 11 may be properly treated by semicircularly bending it two or three times and inserting it into the slits 13a.

The above-described optical wiring structure makes it possible to prevent an optical fiber from being bent to a curvature radius smaller than an allowable curvature radius and properly treat an extra length of the optical fiber. However, members such as the support plate 12, the cushion 13, and the retention plates 17a, 17b are used to provide the above features. It will increase the number of parts and require a space for disposing these members.

### SUMMARY OF THE INVENTION

An object of the present invention is to provide an optical fiber having optical connectors on opposing ends thereof that considerably reduces the space required for optical wiring as compared with the prior art when optical wiring connections are to be made in an apparatus.

According to an aspect of the present invention, there is provided an optical fiber that has optical connectors on opposing ends thereof and is used for optical wiring in an apparatus. The optical connectors are connected in parallel directions and disposed in parallel with each other. The optical fiber between the two optical connectors includes a linear portion and two bent portions positioned between the ends of the linear portion and the optical connectors. The bent portions are formed by application and curing of resin to obtain a circular shape having a central angle of 90°, which provides a curvature radius not smaller than the allowable curvature radius of the optical fiber.

The above-described optical fiber with optical connectors according to the present invention does not require a prior-art extra length treatment process of winding an optical fiber one or more turns. This considerably reduces the space required for optical wiring as compared with the prior art and eliminates the necessity of using a member for extra length treatment.

### BRIEF DESCRIPTION OF THE DRAWINGS

FIG. 1 is a perspective view illustrating a prior-art wiring structure of an optical fiber with optical connectors.

FIG. 2 is a perspective view illustrating an exemplary use of an optical fiber with optical connectors according to one embodiment of the present invention before the connection of the optical connectors.

FIG. 3 is a perspective view illustrating an exemplary use of the optical fiber with optical connectors according to one embodiment of the present invention after the connection of the optical connectors.

FIG. 4 is a plan view illustrating how the optical connectors depicted in FIG. 3 are connected.

FIG. 5A is a diagram illustrating the variation in the length of the optical fiber with optical connectors.

FIG. 5B is a diagram illustrating the variation in the length of the optical fiber with optical connectors.

FIG. 6 is a diagram illustrating how the wiring varies with the variation in the length of the optical fiber.

FIG. 7 is a diagram illustrating how the wiring of the optical fiber varies with the interval between two optical connectors.

### DETAILED DESCRIPTION OF THE EMBODIMENTS

An embodiment of the present invention will now be described.

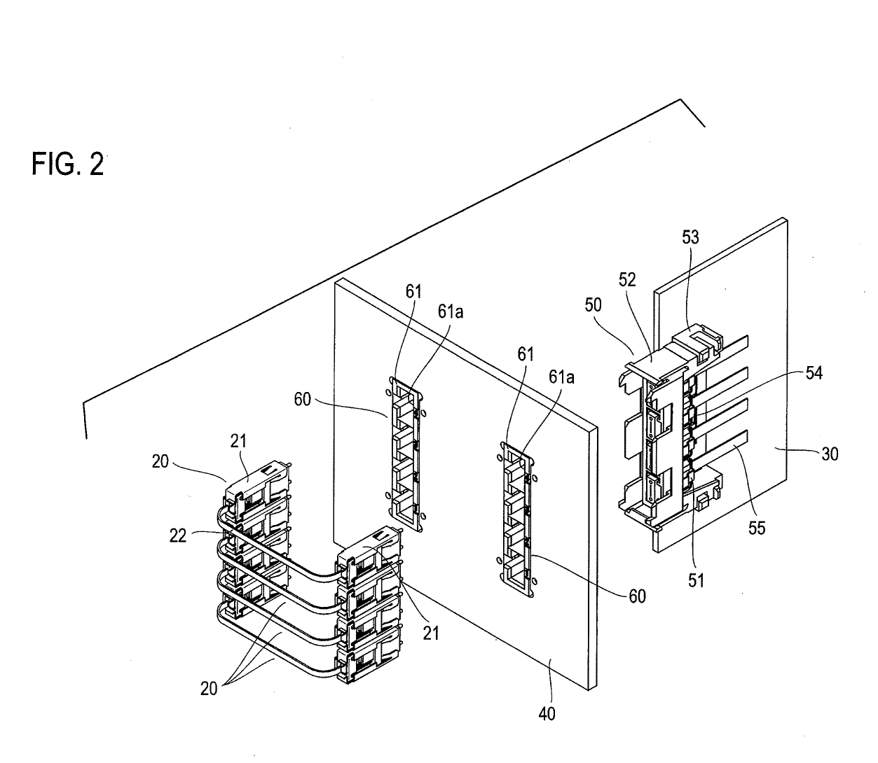

FIG. 2 illustrates an exemplary use of an optical fiber with optical connectors according to one embodiment of the present invention. In FIG. 2, reference numeral 20 denotes the optical fiber with optical connectors according to one embodiment of the present invention. Reference numeral 30 denotes a package board and reference numeral 40 denotes a backboard. The package board 30 and the backboard 40 are disposed so that their board surfaces are oriented orthogonal to each other. First of all, the package board 30 and the backboard 40 will be briefly described.

An optical connector device 50 is mounted on the package board 30. The optical connector device 50 includes a plurality of optical connectors 51 (four optical connectors in the present example), a first housing 52, a second housing 53, and a retention member 54. The first housing 52 houses and retains the optical connectors 51. The second housing 53 retains the first housing 52 in a free floating manner. The retention member 54 fastens the second housing 53 to the package board 30. Reference numeral 55 in FIG. 2 denotes tape fibers to which the optical connectors 51 are attached.

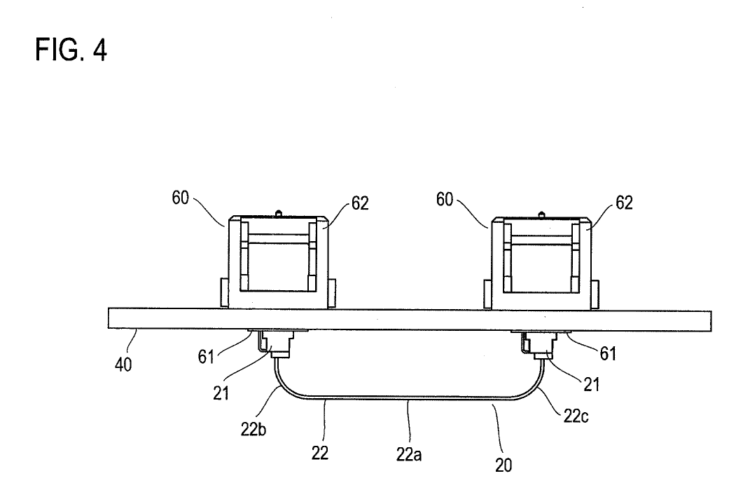

Two optical connector devices 60 are mounted on the backboard 40. The optical connector devices 60 each include an inner housing 61 and an outer housing 62 (see FIG. 4). The inner housing 61 houses and retains an optical connector 21 of the optical-fiber-with-optical-connectors 20. The outer housing 62 removably retains the inner housing 61. The inner housing 61 is floatable from the outer housing 62.

An optical connector accommodation section 61a for housing a plurality of optical connectors 21 (four optical connectors in the present example) is formed on the inner housing 61. The optical connector accommodation section 61a is zoned to house each optical connector 21.

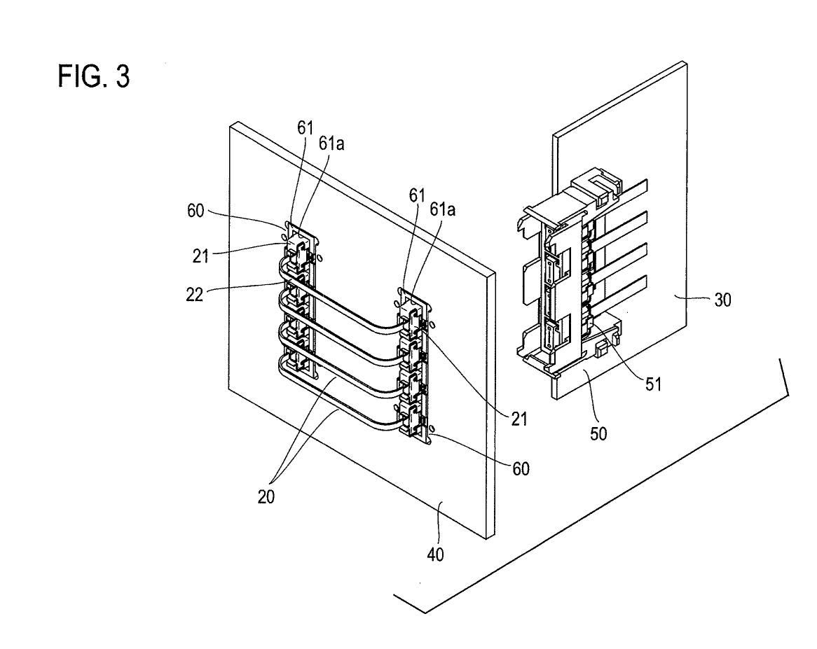

When the optical connectors 21 on opposing ends of the optical-fiber-with-optical-connectors 20 are to be mounted, they are inserted into respective positions of the individual optical connector accommodation sections 61a of the two optical connector devices 60 mounted on the backboard 40. In the present example, four optical-fibers-with-optical-connectors 20 are mounted. FIG. 3 illustrates a state where the optical connectors 21 on opposing ends of the four optical-fibers-with-optical-connectors 20 are mounted on the backboard 40 and optical wiring connections are made within an apparatus through the optical-fibers-with-optical-connectors 20.

The optical connector device 50 mounted on the package board 30 is connected to the optical connector device 60 mounted on the backboard 40. The optical connectors 51 housed and retained by the optical connector device 50 are then optically connected to the optical connectors 21 of the optical-fibers-with-optical-connectors 20.

The configuration of the optical-fiber-with-optical-connectors 20 will now be described.

FIG. 4 illustrates a state where the optical-fiber-with-optical-connectors 20 is mounted on the backboard 40 as described above. The two optical connectors 21 on opposing ends of the optical fiber 22 are connected in parallel directions and disposed in parallel with each other. In the present example, it is assumed that the optical fiber 22 is a multi-core tape fiber.

The optical fiber 22 between the two optical connectors 21 includes a linear portion 22a and two bent portions 22b, 22c positioned between the ends of the linear portion 22a and the optical connectors 21. The bent portions 22b, 22c are formed by application and curing of resin to obtain a circular shape having a central angle of 90°, which provides a curvature radius not smaller than the allowable curvature radius of the optical fiber 22. The bent portions 22b, 22c are formed by application and curing of resin before the optical-fiber-with-optical-connectors 20 is mounted on the backboard 40. The resin used for forming purposes is, for example, UV resin (ultraviolet-curable resin).

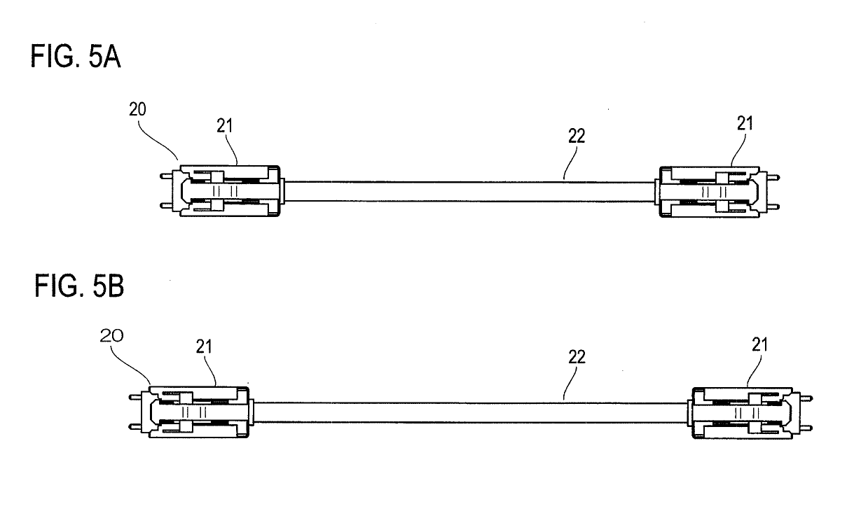

Meanwhile, when the optical-fiber-with-optical-connectors 20 is to be manufactured by attaching the optical connectors 21 to the opposing ends of the optical fiber 22, there is a problem in that the length of the optical-fiber-with-optical-connectors 20 is likely to vary. The variation in the length is attributable, for instance, to the following processes:
(1) Cutting and covering removal of optical fiber
(2) Attachment of ferrule
(3) Polishing of optical fiber end face
   FIGS. 5A and 5B illustrate the variation in the length of the optical-fiber-with-optical-connectors 20.

In the present example, there is no extra length for winding the optical fiber 22 one or more turns. In that respect, if the optical fiber 22 used for optical wiring in an apparatus varies in length, the variation may be absorbed to a certain extent although there is only a limited margin for absorbing the variation. In other words, the optical-fiber-with-optical-connectors 20 may be used for optical wiring in an apparatus even if the optical-fiber-with-optical-connectors 20 varies in length to a certain extent.

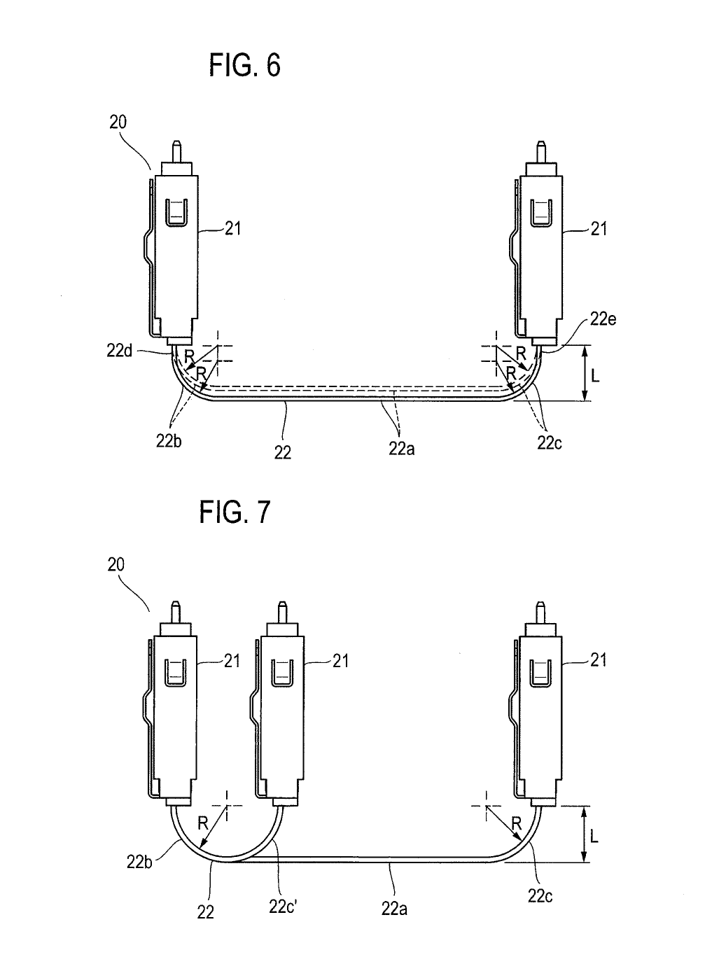

FIG. 6 illustrates the above-mentioned situation. The two optical connectors 21 are mounted at predetermined positions of the backboard 40 and disposed in parallel with each other.

In FIG. 6, the symbol L denotes the connection-direction size (distance) of the optical connectors 21 in an intra-apparatus space (the space behind the backboard 40) that is allowable for optical wiring when optical wiring connections are made with the optical-fiber-with-optical-connectors 20. The symbol R denotes the minimum allowable curvature radius of the optical fiber 22.

The distance of wiring for the optical fiber 22 needs to be not greater than L. The curvature radius of each bent portion 22b, 22c needs to be not smaller than R. Under these restrictions, solid lines are used to represent the wiring of the optical fiber 22 when the length of the optical fiber 22 is maximized, and broken lines are used to represent the wiring of the optical fiber 22 when the length of the optical fiber 22 is minimized. When the length of the optical fiber 22 is maximized as indicated by the solid lines, linear portions 22d, 22e exist between the bent portions 22b, 22c and the optical connectors 21.

In the present example, a certain variation in the length of the optical fiber 22 may be tolerable as described above. Meanwhile, the space required for optical wiring may be extremely smaller than in the past. In that respect, the efficiency in the use of the space in an apparatus can be increased.

FIG. 7 illustrates certain wiring connections that are imposed on the optical fiber 22 when two optical connectors 21 of the optical-fiber-with-optical-connectors 20 are disposed at a narrow interval (mounting pitch) and different wiring connections that are imposed on the optical fiber 22 when the two optical connectors 21 of the optical-fiber-with-optical-connectors 20 are disposed at a wide interval. As is obvious from FIG. 7, when the optical connectors 21 are disposed at an extremely narrow interval, the linear portion 22a of the optical fiber 22 no longer exists and the bent portions 22b, 22c′ join together so that the optical fiber 22 is semicircular in shape.

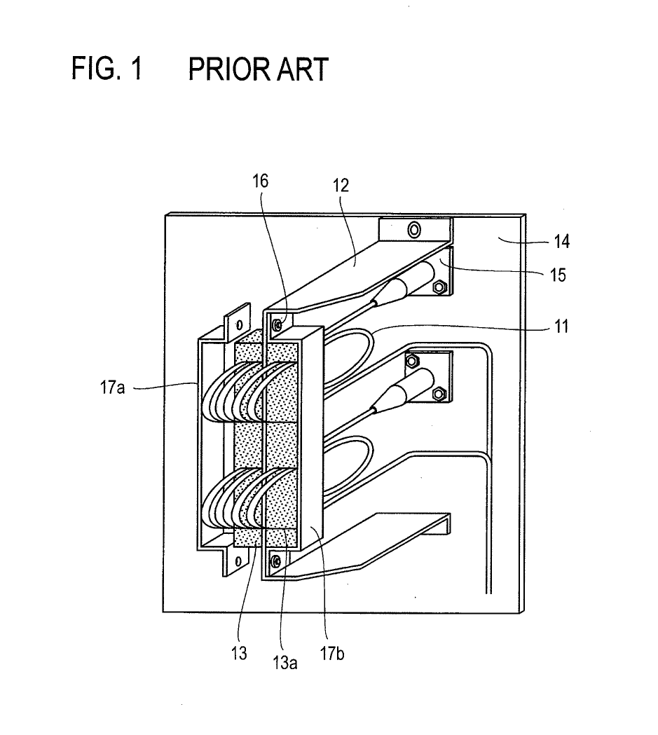

According to the above-described embodiment, the bent portions of the optical fiber are formed before optical wiring so that each bent portion is circular in shape and has a curvature radius not smaller than the allowable curvature radius. Therefore, the shape of the optical fiber remains unimpaired when optical wiring connections are made. When a method of inserting an optical fiber into the slits 13a in the cushion 13 is employed as indicated by the prior-art example depicted in FIG. 1, the bending radius of the optical fiber cannot be strictly controlled. For example, the curvature radius may become smaller than a certain curvature radius depending on how the optical fiber is pulled. Therefore, care must be exercised so that the curvature radius is not smaller than a certain curvature radius. Further, the curvature radius needs to be verified after wiring in order to guarantee that the curvature radius is not smaller than the allowable curvature radius. However, the above-described embodiment saves the trouble of verifying the curvature radius of the optical fiber. This also makes it easy to make optical wiring connections.

In the above-described embodiment, only the bent portions 22b, 22c (22c′) of the optical fiber 22 are formed by application of resin. Alternatively, however, the linear portion 22a may also be formed by application and curing of resin. Further, the resin used for coating is not limited to UV resin. Alternatively, adhesive in liquid or gel state may be used and cured. The optical fiber 22 is not limited to a multi-core tape fiber. An alternative is to use a single-core optical fiber or a multi-layer, multi-core tape fiber. The optical fiber 22 is selected in compliance with specifications for optical wiring.

The foregoing description of the embodiments of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An optical fiber with optical connectors that is used for optical wiring in an apparatus, comprising:
optical connectors on opposing ends of the optical fiber;
wherein the two optical connectors are connected in parallel directions and disposed in parallel with each other;
wherein the optical fiber between the two optical connectors includes a linear portion and two bent portions positioned between the ends of the linear portion and the optical connectors; and
wherein the bent portions are formed by application and curing of resin to obtain a circular shape having a central angle of 90°, which provides a curvature radius not smaller than the allowable curvature radius of the optical fiber.

2. The optical fiber with optical connectors according to claim 1,
wherein the optical fiber is a multi-core tape fiber.

3. The optical fiber with optical connectors according to claim 1,
wherein the two optical connectors are mounted on a backboard of the apparatus.

4. The optical fiber with optical connectors according to claim 2,
wherein the two optical connectors are mounted on a backboard of the apparatus.
